(19) United States
(12) Patent Application Publication
(10) Pub. No.: US 2005/0050331 A1
(43) Pub. Date: Mar. 3, 2005

(54) Watermarking using image processors

(76) Inventors: Vincent C. Skurdal, Bois, ID (US); Mark L. Brown, Bois, ID (US); Shane Gehring, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/650,624

(22) Filed: Aug. 28, 2003

(51) Int. Cl. H04L 9/00

(52) U.S. Cl. 713/176

(57) ABSTRACT

Image processors and methods are provided. One method includes printing a control document indicative of one or more watermarks. Scanning the control document to detect a user mark designative of a selected one of the one or more watermarks is also included in the method, as is scanning printed material. The method also includes adding data corresponding to the selected one of the one or more watermarks to data corresponding to the scanned printed material to form data corresponding to watermarked material.

### BACKGROUND

Watermarks are frequently displayed in the background of printed material, e.g., as an identifier of the printed material, such as for security purposes, for aesthetics, etc. Many watermarked printed materials are produced using digital technology. For example, digital data corresponding to a watermark is often added to digital data corresponding to printed material, such as a printed document, using an external computer to create a digital representation of a watermarked document. The computer then sends the digital representation of the watermarked document to a printer in a printer-usable format for printing the watermarked document.

Some digital image-processing devices, such as digital copiers, etc., are capable of adding watermarks to a printed document without the use of an external computer. Typically, a watermark is either scanned into the image-processing device or is entered into the image-processing device, for example, using a keyboard or a card reader of the image-processing device. The image-processing device converts the watermark into digital data. Then, the image-processing device scans the printed document to which the watermark is to be added and converts the printed document into digital data. The image-processing device adds the digital data corresponding to the watermark to the digital data corresponding to the printed document to create a digital representation of a watermarked document. Then, the image-processing device converts the digital representation of a watermarked document to a printer-usable format and prints out a watermarked document. However, many of these image-processing devices use complex user interfaces that require a user to navigate a number of menus to produce the watermarked document.

### SUMMARY

One embodiment of the present invention provides a method of operating an image processor. The method includes printing a control document indicative of one or more watermarks. Scanning the control document to detect a user mark designative of a selected one of the one or more watermarks is also included in the method, as is scanning printed material. The method also includes adding data corresponding to the selected one of the one or more watermarks to data corresponding to the scanned printed material to form data corresponding to watermarked material.

### DESCRIPTION OF THE DRAWINGS

FIG. 1 is a block diagram of an image processor according to an embodiment of the present invention.

FIG. 2 illustrates a control document according to another embodiment of the present invention.

FIG. 3 is a flowchart of a method according to another embodiment of the present invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

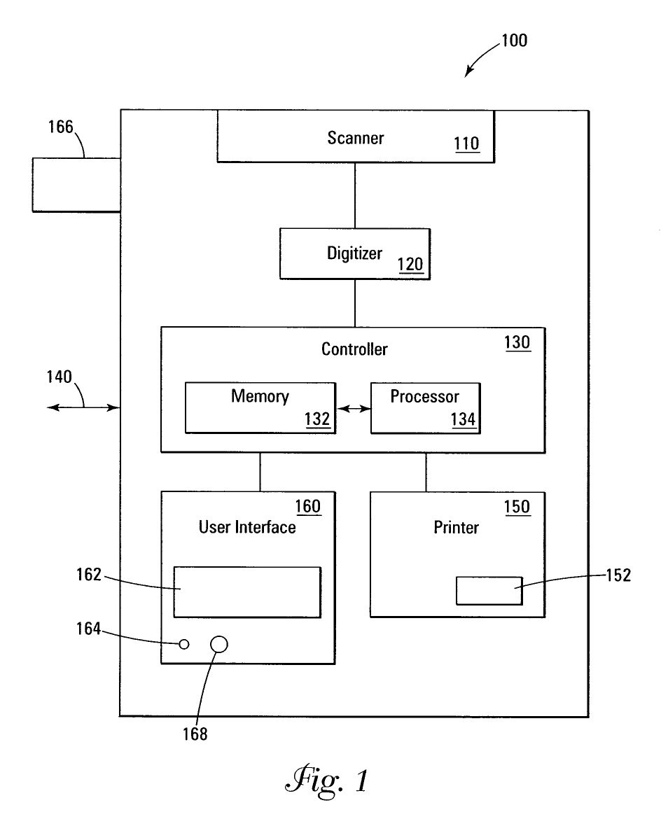

FIG. 1 is a block diagram of a digital image processor 100, such as a digital copier, digital sender, multifunction copier, etc., according to an embodiment of the present invention. Image processor 100 includes a scanner 110 connected to a digitizer 120, such as an analog-to-digital converter. A controller 130 is connected to digitizer 120. For one embodiment, scanner 110 scans in printed material, such as a printed document, and converts the printed material into analog electrical signals. Digitizer 120 receives the analog electrical signals from scanner 110 and converts the analog electrical signals into digital data. Digitizer 120 sends the digital data to controller 130.

For one embodiment, controller 130 is adapted to format the data received from scanner 1 10 into a printer-usable format, such as a bitmap, Portable Document Format (PDF), Tag Image File Format (TIFF), Joint Photographic Experts Group (JPEG), etc. For one embodiment, controller 130 is adapted to transmit digital data corresponding to the scanned printed material, e.g., in a printer-usable format, to one or more destination addresses on a data network via an interface 140. For one embodiment, the destination addresses are network addresses of network devices (printers, servers, workstations, storage devices, etc.), electronic messaging addresses (e.g., email), facsimile (fax) numbers, etc., and the data network is a Local Area Network, the Internet, or the like.

For another embodiment, digital image processor 100 includes a printer 150, such as a laser printer, an ink-jet printer, etc., connected to controller 130. For one embodiment, controller 130 is adapted to send the printer-usable data to a printer 150 for printing. For another embodiment, printer 150 includes a supply of printable media 152, such as paper, on which a copy of the printed material is printed.

Controller 130 includes a memory 132, e.g., a computer-usable storage media that can be fixedly or removably attached to digital image processor 100. Some examples of computer-usable media include static or dynamic random access memory (SRAM or DRAM), read-only memory (ROM), electrically-erasable programmable ROM (EEPROM or flash memory), magnetic media and optical media, whether permanent or removable. Memory 132 may include more than one type of computer-usable media for storage of differing information types.

In various embodiments, memory 132 stores digital data received from digitizer 120 for subsequent formatting by controller 130. For another embodiment, memory 132 contains computer-readable instructions, e.g., drivers, adapted to cause a processor 134 of controller 130 to format the data received from digitizer 120 and computer-readable instructions to cause processor 134 to cause digital image processor 100 to perform various methods, as described below. For one embodiment, image processor 100 includes a user interface 160 that in another embodiment includes a graphical display 162.

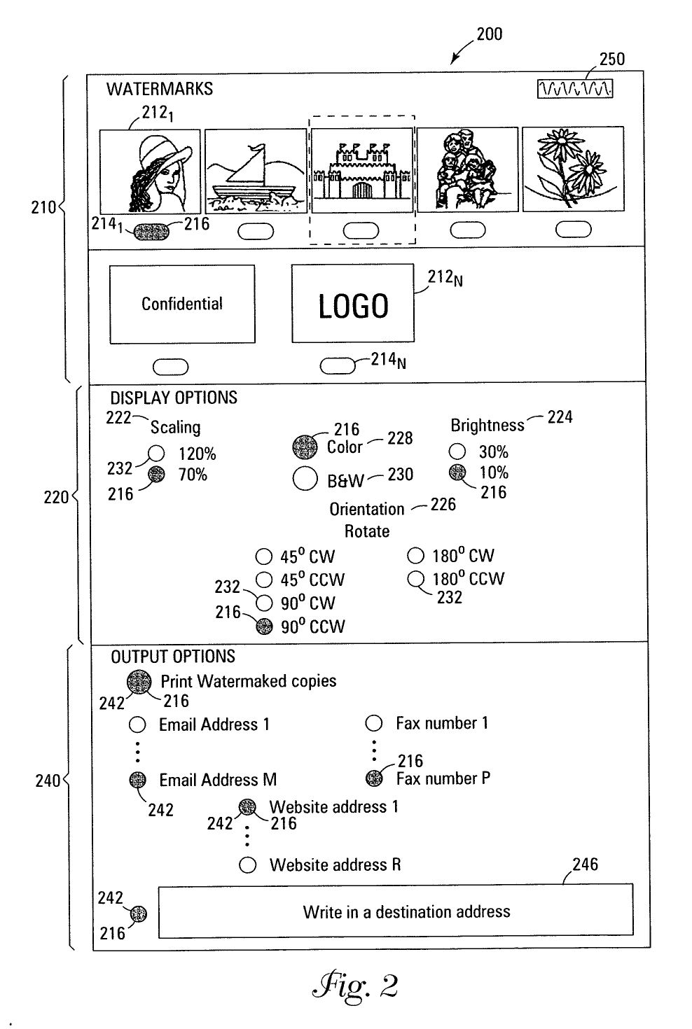

FIG. 2 illustrates a watermark control document 200 according to another embodiment of the present invention. For one embodiment, printer 150 of image processor 100 prints out control document 200 on the printable media when a user of image processor 100 activates a control-document print key 164 (FIG. 1) of user interface 160. For another embodiment, control-document print key 164 is integrated in display 162.

For one embodiment, control document 200 includes a watermark section 210. Watermark section 210 displays thumbnails 212₁ to 212_{N} of images that can be added as watermarks to printed material that is scanned into image processor 100. The watermark section, for another embodiment, can include more than one page of control document 200, depending on the number and/or size of thumbnails 212. For some embodiments, thumbnails 212 are thumbnails of images, such as pictures, text, logos, etc., that were pre-scanned into image processor 100 and stored as data, corresponding to the pre-scanned images, in memory 132 of image processor 100.

For other embodiments, thumbnails 212 are thumbnails of images stored as data in a removable storage media 166 (shown in FIG. 1) removably connectable to image processor 100. Examples of storage media 166 include flash memory cards (e,g., CompactFlash available from SanDisk Corporation, Sunnyvale, Calif., USA, and Memory Stick available from Sony Corporation, Japan), floppy disks, compact discs, Universal Serial Bus (USB) drives, etc. For one embodiment, image data corresponding to the images stored in storage media 166 is stored in memory 132 before the thumbnails 212 are printed. For another embodiment, the images stored in storage media 166 are printed as thumbnails 212 directly from storage media 166.

For another embodiment, open symbols 214₁ to 214_{N}, e.g., circles, ellipses, boxes, etc., are respectively disposed adjacent thumbnails 212₁ to 212_{N}. To add a watermark to printed material scanned into image processor 100, a thumbnail 212 corresponding to the image that is to be added as a watermark is designated by a user making a mark adjacent the thumbnail 212, e.g., by placing the mark within the symbol 214 corresponding to the thumbnail 212. For example, to add the image corresponding to thumbnail 212₁ to the printed material, the user places a mark 216 in symbol 214₁, as shown in FIG. 2.

For another embodiment, watermark control document 200 includes a display options section 220 that can include scaling options 222, brightness options 224, orientation options 226, a color option 228, a black-and-white option 230, etc. The display options provide various options for displaying an image as a watermark on printed material. For one embodiment, an open symbol 232, e.g., a circle, an ellipse, a box, etc., is disposed adjacent each of the display options. For another embodiment, a user places mark 216 in one or more open symbols 232 corresponding to the one or more display options to be selected. For example, when marks 216 are placed within open symbols 232 as shown in FIG. 2 and are scanned into image processor 100, image processor displays the image corresponding to thumbnail 212₁ on the printed material in color, at 70 percent of its original size, at ten percent of its original brightness, and rotated 90 degrees counterclockwise from its original position.

For another embodiment, watermark control document 200 includes an output options section 240 that can include an option for printing watermarked copies of the printed material at printer 150 and/or sending the watermarked copies a destination address, such as an email address, fax number, website address, etc. For one embodiment, an open symbol 242, e.g., a circle, an ellipse, a box, etc., is disposed adjacent each of the output options. For another embodiment, a user places mark 216 in one or more open symbols 242 corresponding to the one or more output options to be selected. For example, when marks 216 are placed within open symbols 242 as shown in FIG. 2 and are scanned into image processor 100, image processor prints out one or more copies of watermarked printed material and sends data corresponding to the watermarked printed material to a preprogrammed email address 1, a preprogrammed fax number P, a preprogrammed website address 1, and a destination address, such as a website address, fax number, and/or email address, that is entered in a space 246, e.g., by typing, of the output options section 240. For one embodiment, an optical character recognition (OCR) program stored in memory 132 causes processor 134 to interpret the destination address in region 246 and to send the watermarked printed material to that destination address.

For another embodiment, watermark control sheet 200 includes an indicator 250, such as a bar code, that when detected by image processor 100, places image detector 100 in a watermark mode of operation. For other embodiments, user activation of a watermark-mode-selection key 168 (FIG. 1) of user interface 160 places image processor 100 into the watermark mode of operation. For another embodiment, watermark-mode-selection key 168 is integrated in display 162. For various embodiments, while operating in the watermark mode, image processor 100 adds a watermark corresponding to a selected one of thumbnails 212 to printed material that is scanned by image processor 100. For one embodiment, position vectors (not shown) originating at indicator 250 specify the locations of thumbnails 212, each of the display options, each of the output options, and open symbols 214, 232, and 242, and thus each of marks 216 relative to indicator 250. For example, indicator 250 may be the origin of a coordinate system, e.g., Cartesian coordinate system, and the position vectors row or column vectors having as elements coordinates of the locations or bounding regions of the respective thumbnails 212, display options, output options, and open symbols 214, 232, and 242.

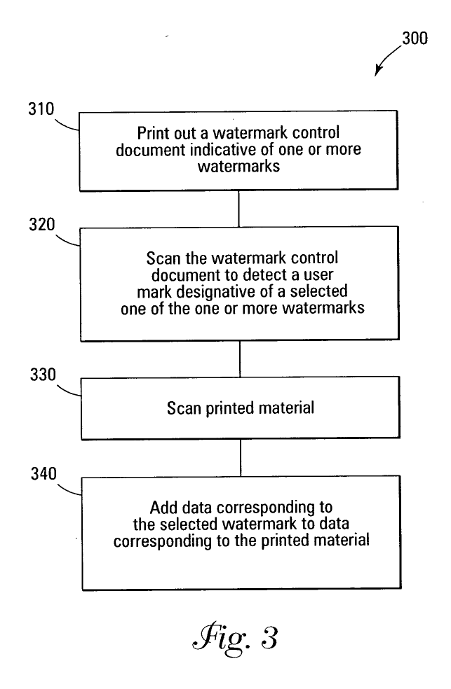

For various embodiments, the computer-readable instructions of image processor 100 cause image processor 100 to perform a method 300, as illustrated by a flowchart in FIG. 3. At block 310, image processor 100 prints out watermark control document 200, e.g., in response to a user activating control-document print key 164. For some embodiments, this involves image processor 100 generating the thumbnails 212 from data corresponding to images in memory 132 and/or removable memory 166. Image processor 100 then adds the thumbnails to an electronic version of watermark control document 200 that is in a printer-usable format.

After printing watermark control document 200, the user places a mark 216 adjacent a thumbnail 212 to designate the thumbnail 212 as corresponding to a selected watermark. For example, the user fills in an open symbol 214 corresponding to the thumbnail 212 with mark 216. At block 320, image processor 100 scans control document 200 to detect the mark 216. For one embodiment, image processor 100 detects the indicator 250 before detecting mark 216, which instructs image processor to operate in the watermark mode of operation. For another embodiment, the user places image processor 100 in a watermark mode of operation using watermark-mode-selection key 168 before control document 200 is scanned.

Upon detecting mark 216, image processor 100 selects an image, e.g., from memory 132 or removable memory 166, corresponding to the designated thumbnail 212 as a watermark to be added to printed material. For other embodiments, image processor 100 detects marks 216 corresponding to the various options for displaying the selected image on the printed material and/or the various options for outputting the watermarked printed material.

At block 330, the printed material is scanned by scanner 110 while image processor 100 is in the watermark mode of operation. At block 340, data corresponding to the selected image to be added as a watermark is added to data corresponding to the printed material to form data corresponding to watermarked material. For one embodiment, the data corresponding the watermarked material is converted to a printer usable format. For another embodiment, this includes implementing one or more display options of the display options section 220 as a result of image processor detecting marks 216 corresponding to the one or more display options. For one embodiment, printer 150 prints the watermarked material as a result of image processor detecting a mark 216 corresponding to the output option (or print instruction) “Print Watermarked Copies.” For some embodiments, image processor 100 sends the data corresponding to the watermarked printed material to one or more destination addresses specified in the output options section 240 as a result of image processor 100 detecting marks 216 corresponding to the one or more destination addresses.

### Conclusion

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

1. A method of operating an image processor, the method comprising:
printing a control document indicative of one or more watermarks;
scanning the control document to detect a first user mark that is a designative of a selected one of the one or more watermarks; and
adding data corresponding to the selected one of the one or more watermarks to data corresponding to printed material to form data corresponding to watermarked material.

2. The method of claim 1, further comprising printing the watermarked material.

3. The method of claim 2, wherein printing the watermarked material is a result of detecting a second user mark corresponding to a printing instruction in response to scanning the control document.

4. The method of claim 1, further comprising sending the data corresponding to the watermarked material to one or more destination addresses as a result of detecting one or more second user marks respectively corresponding to the one or more destination addresses in response to scanning the control document.

5. The method of claim 1, further comprising displaying the selected one of the one or more watermarks on the printed material according to one or more display options as a result of detecting one or more second user marks respectively corresponding to the one or more display options in response to scanning the control document.

6. The method of claim 1, wherein adding data corresponding to the selected one of the one or more watermarks comprises receiving the data corresponding to the selected one of the one or more watermarks, as a result of detecting the first user mark, from a removable memory removably connected to the image processor.

7. The method of claim 1, further comprising placing the image processor in a watermarking mode of operation.

8. The method on claim 7, wherein placing the image processor in the watermarking mode is in response to detecting an indicator while scanning the control sheet or is in response to the user activating a watermark-mode-selection key of the image processor.

9. The method of claim 1, wherein printing the control document is in response to the user activating a control-document print key of the image processor.

10. A method of operating a multifunction copier, the method comprising:
printing a watermark control document comprising one or more thumbnail images respectively corresponding to one or more watermarks;
scanning the control document to detect a first user mark designating one of the one or more thumbnail images for selecting the corresponding watermark;
scanning printed material;
adding the selected watermark to the printed material to form watermarked material; and
printing the watermarked material.

11. The method of claim 10, further comprising, before printing the watermark control document, generating the one or more thumbnail images from data corresponding to the one or more corresponding watermarks stored in at least one of a memory of the multifunction copier and a removable memory removably connected to the multifunction copier.

12. The method of claim 10, wherein adding the selected watermark to the printed material comprises adding data corresponding to selected watermark that is stored in either a memory of the multifunction copier or a removable memory removably connected to the multifunction copier to data corresponding to the printed material.

13. The method of claim 10, further comprising displaying the selected watermark on the printed material according to one or more display options as a result of detecting one or more second user marks respectively corresponding to the one or more display options in response to scanning the watermark control document.

14. A computer-usable media containing computer-readable instructions for causing an image processor to perform a method, the method comprising:
generating a control document indicative of one or more watermarks;
detecting a first user mark designative of a selected one of the one or more watermarks in response to scanning the control document; and
adding data corresponding to the selected one of the one or more watermarks to data corresponding to printed material to form data corresponding to watermarked material.

15. The computer-usable media of claim 14, wherein the method further comprises printing the watermarked material.

16. The computer-usable media of claim 15, wherein, in the method, printing the watermarked material is a result of detecting a second user mark corresponding to a printing instruction in response to scanning the control document.

17. The computer-usable media of claim 14, wherein the method further comprises sending the data corresponding to the watermarked material to one or more destination addresses as a result of detecting one or more second user marks respectively corresponding to the one or more destination addresses in response to scanning the control document.

18. The computer-usable media of claim 14, wherein the method further comprises displaying the selected one of the one or more watermarks on the printed material according to one or more display options as a result of detecting one or more second user marks respectively corresponding to the one or more display options in response to scanning the control document.

19. The computer-usable media of claim 14, wherein, in the method, adding data corresponding to the selected one of the one or more watermarks comprises receiving the data corresponding to the selected one of the one or more watermarks, as a result of detecting the first user mark, from a removable memory removably connected to the image processor.

20. A computer-usable media containing computer-readable instructions for causing a multifunction copier to perform a method, the method comprising:
generating one or more thumbnail images respectively corresponding to one or more watermarks from data stored in at least one of a memory of the multifunction copier and a removable memory removably connected to the multifunction copier;
printing a control document containing the one or more thumbnail images;
detecting a first user mark designating one of the one or more thumbnail images for selecting the corresponding watermark;
scanning printed material;
adding data corresponding to the selected watermark to data corresponding to the scanned printed material to form data corresponding to watermarked material; and
printing the watermarked material.

21. The computer-usable media of claim 20, wherein the method further comprises displaying the selected watermark on the printed material according to one or more display options as a result of detecting one or more second user marks respectively corresponding to the one or more display options in response to scanning the control document.

22. The computer-usable media of claim 20, wherein the method further comprises adding the one or more thumbnail images to an electronic version of the control document before printing the control document.

23. A multifunction copier comprising:
means for generating one or more thumbnail images respectively corresponding to one or more watermarks from data stored in at least one of a memory of the multifunction copier and a removable memory removably attached to the multifunction copier;
means for printing a control document containing the one or more thumbnail images;
means for detecting a first user mark designating one of the one or more thumbnail images for selecting the corresponding watermark;
means for scanning printed material;
means for adding the selected watermark to the printed material to form watermarked material; and
means for printing the watermarked material.

24. The multifunction copier of claim 23, further comprising means for adding the one or more thumbnail images to an electronic version of the control document before printing the control document.

25. A multifunction copier comprising:
a scanner;
a digitizer connected to the scanner;
a controller connected to the digitizer; and
a printer connected to the controller;
wherein the controller is adapted to cause the multifunction copier to perform a method, the method comprising:
printing a control document indicative of one or more watermarks using the printer;
detecting a first user mark designative of a selected one of the one or more watermarks in response to scanning the control document;
scanning printed material using the scanner;
converting the printed material into data corresponding to the printed material using the digitizer; and
adding data corresponding to the selected one of the one or more watermarks to the data corresponding to the scanned printed material to form data corresponding to watermarked material; and
printing the watermarked material using the printer.

26. The multifunction copier of claim 25, wherein the method further comprises displaying the selected watermark on the printed material according to one or more display options as a result of detecting one or more second user marks respectively corresponding to the one or more display options in response to scanning the control document.
